(19) United States
(12) Patent Application Publication
(10) Pub. No.: US 2010/0064343 A1
(43) Pub. Date: Mar. 11, 2010

(54) OPERATION SUPPORTING APPARATUS AND OPERATION SUPPORTING METHOD

(75) Inventor: Shoh Konagaya, Mishima-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/555,992

(22) Filed: Sep. 9, 2009

Related U.S. Application Data
(60) Provisional application No. 61/095,497, filed on Sep. 9, 2008.

(51) Int. Cl. H04L 9/32

(52) U.S. Cl. 726/2

(57) ABSTRACT

There is provided an operation supporting technique by which an operation environment which is set in an apparatus for each user can be more easily reflected in another apparatus. An operation supporting apparatus includes an authentication section to authenticate a user by acquiring authentication information from a storage medium to store the authentication information used for user authentication and specific information about a location of setting information about setting contents of an operation environment of the user, a specific information acquisition section to acquire the specific information from the storage medium from which the authentication information is acquired, a setting information acquisition section to acquire, when the authentication section succeeds in the authentication of the user, the setting information by using the specific information acquired by the specific information acquisition section from the storage medium from which the authentication information of the user is acquired, and a setting reflection section to cause setting contents based on the setting information acquired by the setting information acquisition section to be reflected in the operation environment of the user.

### CROSS-REFERENCE TO RELATED APPLICATION

This application is based upon and claims the benefit of priority from: U.S. provisional application 61/095, 497, filed on Sep. 9, 2008; the entire contents of each of which are incorporated herein by reference.

### TECHNICAL FIELD

The present invention relates to an operation supporting apparatus, and particularly to an operation supporting technique capable of acquiring setting information about setting contents of an operation environment of a user.

### BACKGROUND

Hitherto, there is known a technique for performing user authentication by an IC card or another authentication function in an apparatus such as a digital multi function peripheral (MFP). Besides, as an apparatus having the authentication function as stated above, for example, there is known an apparatus capable of performing user-specific setting of an operation environment of a user. For these apparatuses, there is a user's request to enable the setting of the operation environment specific to each user, which is set for a certain apparatus, to be used when another different apparatus is used.

Thus, a method is proposed in which the setting of an operation environment in a certain apparatus is reflected in another apparatus.

For example, there is known a technique in which setting information about the setting of an operation environment in an apparatus is converted into a barcode, and the barcode is outputted to a paper medium (JP-A-5-114969). When the technique is adopted, in an apparatus in which the setting contents is to be reflected, the barcode outputted to the paper medium is read by a scanner to acquire the setting information, and the setting contents indicated by the setting information are reflected in the operation environment of the user in the apparatus.

However, when the setting contents are reflected in the another apparatus by using the barcode outputted to the paper medium, the operation of causing the barcode to be read in the another apparatus must be performed by the user himself/herself and is troublesome. Besides, as the data amount of data indicating the setting contents increases, the number of paper media to which the barcode is outputted becomes large, and accordingly, the technique is inconvenient for handling a large amount of data.

There is also known a technique to cause the setting of an operation environment in an apparatus to be reflected in another apparatus through a network (JP-A-2006-93854). When the technique is adopted, first, in addition to an apparatus such as an MFP, a management apparatus to acquire and mange data through the network is installed in a network system. When the user performs setting of the operation environment of an apparatus on the network system, the setting information about the setting contents is stored in the management apparatus. When the setting contents are reflected in another apparatus different from the apparatus in which the setting is performed, the another apparatus as the reflection object is made to acquire the setting information stored in the management apparatus, and the setting contents indicated by the setting information are reflected in the operation environment of the user in the apparatus.

However, when the setting contents are reflected in the another apparatus by the technique, as the premise, it is necessary to provide the management apparatus in the network system. Accordingly, it is necessary to perform daily maintenance of the management apparatus in addition to the MFP, and much labor is required. Besides, when an apparatus such as an MFP is newly installed in the network system, it is necessary to perform setting so that the communication with the management apparatus is enabled.

### SUMMARY

It is an object of an embodiment of the invention to provide an operation supporting technique by which an operation environment which is set in an apparatus for each user can be easily reflected in another apparatus.

In order to achieve the object, according to an aspect of the invention, an operation supporting apparatus includes an authentication section to authenticate a user by acquiring authentication information from a storage medium to store the authentication information used for user authentication and specific information about a location of setting information about setting contents of an operation environment of the user, a specific information acquisition section to acquire the specific information from the storage medium from which the authentication information is acquired, a setting information acquisition section to acquire, when the authentication section succeeds in the authentication of the user, the setting information by using the specific information acquired by the specific information acquisition section from the storage medium from which the authentication information of the user is acquired, and a setting reflection section to cause setting contents based on the setting information acquired by the setting information acquisition section to be reflected in the operation environment of the user.

Besides, according to another aspect of the invention, an operation supporting apparatus includes an authentication section to authenticate a user by acquiring authentication information from a storage medium to store the authentication information used for user authentication and setting information about setting contents of an operation environment of the user, a setting information acquisition section to acquire, when the authentication section succeeds in the authentication of the user, the setting information from the storage medium from which the authentication information of the user is acquired, and a setting reflection section to cause setting contents based on the setting information acquired by the setting information acquisition section to be reflected in the operation environment of the user.

Besides, according to another aspect of the invention, an operation supporting method includes authenticating a user by acquiring authentication information from a storage medium to store the authentication information used for user authentication and specific information about a location of setting information about setting contents of an operation environment of the user, acquiring the specific information from the storage medium from which the authentication information is acquired, acquiring, when the authentication of the user is successful, the setting information by using the specific information acquired from the storage medium from which the authentication information of the user is acquired, and causing the setting contents based on the acquired setting information to be reflected in the operation environment of the user.

Besides, according to another aspect of the invention, an operation supporting program causes a computer to execute a process including authenticating a user by acquiring authentication information from a storage medium to store the authentication information used for user authentication and specific information about a location of setting information about setting contents of an operation environment of the user, acquiring the specific information from the storage medium from which the authentication information is acquired, acquiring, when the authentication of the user is successful, the setting information by using the specific information acquired from the storage medium from which the authentication information of the user is acquired, and causing the setting contents based on the acquired setting information to be reflected in the operation environment of the user.

### DESCRIPTION OF THE DRAWINGS

FIG. 1 is a schematic view showing the outline of a structure of a network system of a first embodiment of the invention.

FIG. 2 is a view illustrating a data table according to the first embodiment of the invention, which is stored in an IC card 113 and in which a user ID is correlated with specific information.

FIG. 3 is a function block diagram of an MFP 101 according to the first embodiment of the invention.

FIG. 4 is a view illustrating a request screen for acquiring a setting request according to the first embodiment of the invention.

FIG. 5 is a view illustrating setting log information stored in a storage area 101b of the MFP 101 according to the first embodiment of the invention.

FIG. 6 is a view illustrating a request screen for acquiring an update request according to the first embodiment of the invention.

FIG. 7 is a view illustrating a process flow of the reflection of setting contents into an operation environment according to the first embodiment of the invention.

FIG. 8 is a view showing a process flow of the acquisition of the setting information according to the first embodiment of the invention.

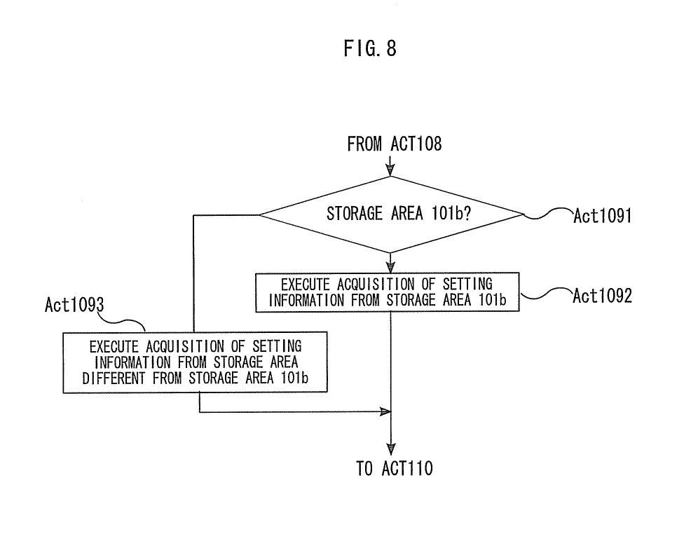

FIG. 9 is a view showing a process flow of the change of setting of the operation environment according to the first embodiment of the invention.

FIG. 10 is a view illustrating a data table according to a second embodiment of the invention, which is stored in an IC card 113 and in which a user ID is correlated with specific information.

FIG. 11 is a view illustrating setting log information stored in a storage area 101b of an MFP 101 according to the second embodiment of the invention.

FIG. 12 is a view showing a process flow of the acquisition of setting information according to the second embodiment of the invention.

FIG. 13 is a view showing a process flow of the change of setting of an operation environment according to the second embodiment of the invention.

FIG. 14 is a view illustrating setting log information stored in a storage area 101b of an MFP 101 of a third embodiment of the invention.

FIG. 15 is a function block diagram of the MFP 101 according to the third embodiment of the invention.

FIG. 16 is a view showing a process flow of the acquisition of setting information according to the third embodiment of the invention.

FIG. 17 is a schematic view showing the outline of a structure of an MFP 101 and a USB memory 115 according to a fourth embodiment of the invention.

FIG. 18 is a function block diagram of the MFP 101 according to the fourth embodiment of the invention.

FIG. 19 is a view illustrating a data table which is stored in a storage area 101b of the MFP 101 of the fourth embodiment of the invention and in which a user ID is correlated with setting information.

FIG. 20 is a view illustrating a process flow of the reflection of setting contents into an operation environment according to the fourth embodiment of the invention.

FIG. 21 is a view illustrating a request screen for acquiring a setting request according to another embodiment of the invention.

### DETAILED DESCRIPTION

Hereinafter, embodiments of the invention will be described with reference to the drawings.

### First Embodiment

First, a first embodiment of the invention will be described with reference to the drawings.

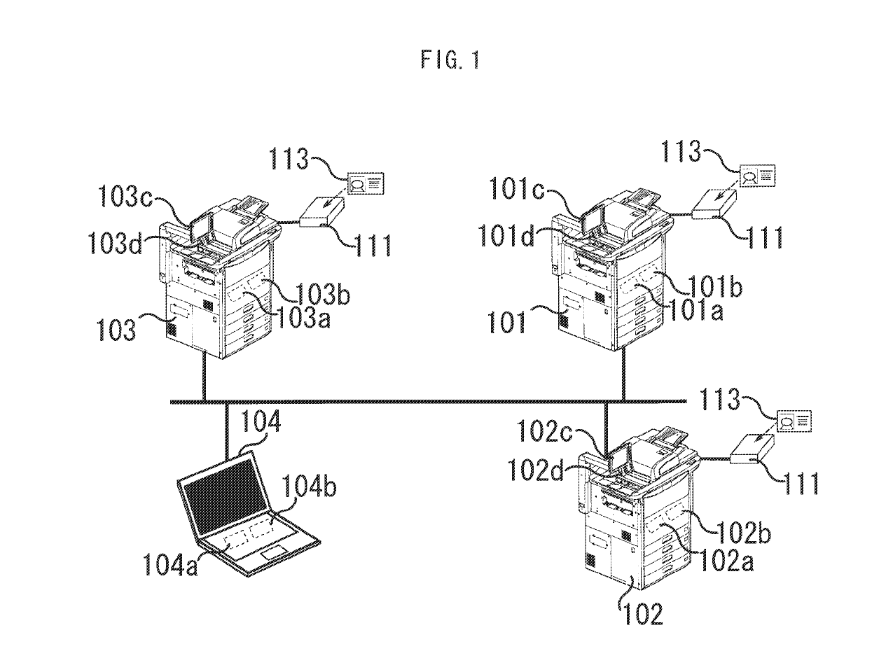

FIG. 1 is a block diagram showing the outline of a structure of a network system which includes an MFP 101 (corresponding to an operation supporting apparatus), an MFP 102, and an MFP 103 and in which these structural components are connected through a network such as a LAN, a WAN or a wireless LAN. Incidentally, when a component common to the MFP 101, the MFP 102 and the MFP 103 is described, these are simply collectively referred to as the MFP.

The MFP includes a CPU (101a, 102a, 103a), and a storage area (101b, 102b, 103b) such as a RAM, a ROM or a hard disk. The CPU executes an application program stored in the storage area and can perform a specified process. Incidentally, in the first embodiment, the storage area of each MFP is the concept including, for example, a storage medium connected through a USB interface in addition to the built-in storage medium.

Besides, the MFP includes a display (101c, 102c, 103c), and an operation section (101d, 102d, 103d) including a graphical display having a touch panel sensor, dedicated buttons frequently used for numerical values, start, cancel and the like, and a state display LED. Further, the MFP includes a scanner, a printer and standard components such as a network interface for communicating with the outside through a network, and an external equipment interface (for example, a USB interface) for communicating with an external equipment.

Accordingly, the MFP executes an application program stored in the storage area based on a request from a user acquired through the network or the operation section, and can execute a process such as monochrome or color copying, monochrome or color scanning, or monochrome or color printing.

Besides, the MFP can store various data in the storage area in addition to the foregoing application program. For example, the storage area 101b of the MFP 101 of the first embodiment includes setting information, information about the user, initial setting information, and setting log information.

The setting information is the information about the setting contents of an operation environment of the user. Incidentally, in the present specification, the operation environment is the use condition of the MFP which can be set for each user. The setting information is specifically, for example, an address book for grouping, storing and managing the mail addresses of previously registered transmission partners, a user template of forms of documents, or a screen layout for display indication in an operation or the like.

In the first embodiment, the user allowed to use an MFP in the network system shown in FIG. 1 can cause the previously specified MFP in the network system to store, as the setting information, the setting contents of his/her own operation environment. Here, the MFP can acquire or send data stored in the storage area through the network or the like, and in first embodiment, the MFP 101 can acquire the setting information from another MFP through the network (described later in detail).

Incidentally, in the first embodiment, each of the storage areas of the MFP 102 and the 103 store one or more pieces of setting information, and users corresponding to these pieces of stored setting information are different from each other.

The information about the user is the information about one or more users previously allowed to use the apparatus included in the network system shown in FIG. 1. The information about the user can be constructed of, for example, a user ID as identification information for specifying each user. Accordingly, in other words, in the first embodiment, one or more user IDs are stored in the storage area of the MFP. The user ID stored in the storage area can be used for authentication of the user as described later.

Incidentally, in the first embodiment, each of the MFP 102 and the MFP 103 includes information about the user. The user IDs included in the information about the user stored in the respective MFPs may be the same or may be different from each other.

The initial setting information is the information about initial setting previously defined for the operation environment in the MFP 101. The initial setting information is also stored in the MFP 102 and the MFP 103. When functions provided in the respective MFPs are different from each other, the initial setting contents based on the initial setting information are also different from each other.

The setting log information is such that when the setting contents based on the setting information or the initial setting contents are reflected in the operation environment of the user in the MFP 101 corresponding to the operation supporting apparatus, the information about the reflected setting contents are stored as the record (log). Accordingly, an item (for example, after-mentioned specific information) stored as the setting log information is correlated with parameters such as the date of reflection into the operation environment and is stored in the storage area 101b. Incidentally, in the following description, it is assumed that with respect to an item stored as the setting log information, even when the relation to the date is not recited, the item is naturally correlated with the date of reflection into the operation environment and is stored.

Further, each MFP uses an attached authentication card reader 111 for acquiring identification information of the IC card 113 owned by the user, and can acquire the user ID (corresponding to authentication information) usable for authentication of the user from the IC card 113. Then, based on the information about the user stored in the storage area, the MFP uses the user ID acquired from the IC card 113 and executes an authentication process of the user. That is, the MFP has a structure in which only when the authentication is successful, the process request through the operation section is accepted.

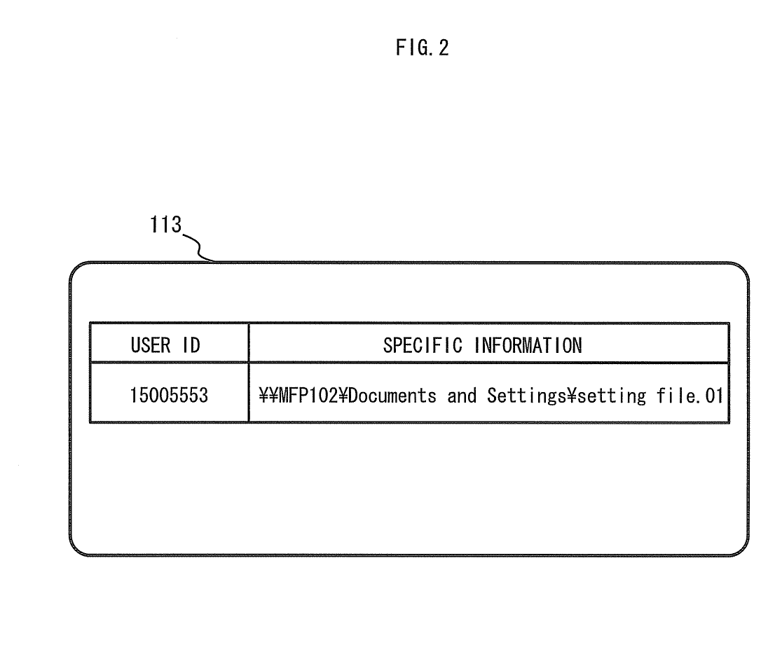

Here, in the first embodiment, specific information correlated with the user ID as shown in FIG. 2 is stored in the IC card 113 in which the user ID is stored. In the present specification, the specific information is the information indicating the location of the setting information specific to the owner of the IC card 113. In the first embodiment, the MFP 101 corresponding to the operation supporting apparatus as the setting object of the operation environment of the user can acquire the setting information by using the specific information (described later in detail).

Incidentally, although the outline of the structure of the network system of the first embodiment is described, the network system generally includes one or more client PCs 104 each of which includes a CPU 104a and a storage area 104b and can execute a standard process.

Besides, in the first embodiment, information to be included in the IC card 113 can be stored in the IC card 113 when, for example, the user is allowed to use an equipment constituting the network.

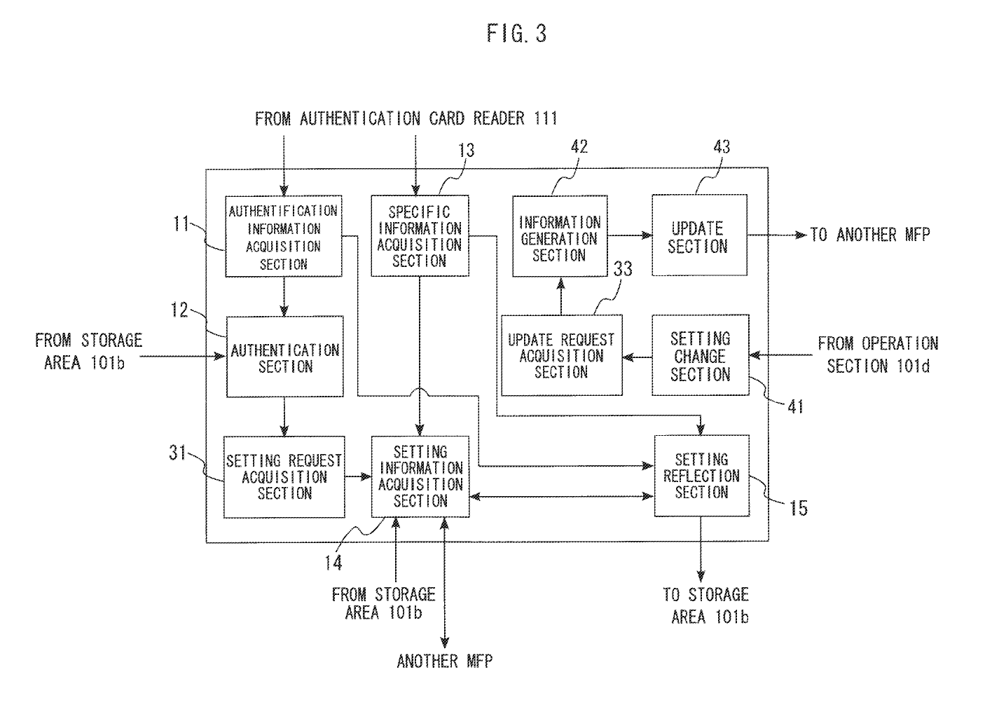

Next, a block structure about functions relating to the reflection of setting contents into an operation environment and the change of setting of the operation environment will be described in detail with reference to FIG. 3. The MFP 101 includes an authentication information acquisition section 11, an authentication section 12, a specific information acquisition section 13, a setting information acquisition section 14, a setting reflection section 15, a setting request acquisition section 31, an update request acquisition section 33, a setting change section 41, an information generation section 42, and an update section 43.

In these, first, the function block relating to the reflection of the setting contents into the operation environment will be described.

The authentication information acquisition section 11 acquires the user ID acquired from the IC card 113 by the authentication card reader 111 attached to the MFP 101, and sends it to the authentication section 12 and the setting reflection section 15.

The authentication section 12 uses the user ID acquired from the authentication information acquisition section 11 and authenticates the user. Specifically, when the user ID is acquired, the authentication section 12 acquires information (previously stored one or more user IDs) about the user from the storage area 101b. Next, the authentication section 12 executes authentication by determining whether the user ID acquired from the IC card 113 is included in the information about the user. When the authentication is successful, the authentication section 12 sends a notification, which informs the authentication success, to the setting request acquisition section 31.

The specific information acquisition section 13 acquires the specific information which is acquired from the IC card 113 by the authentication card reader 111 attached to the MFP 101 and relates to the location of the setting information set by the user owning the IC card 113, and sends it to the setting information acquisition section 14 and the setting reflection section 15.

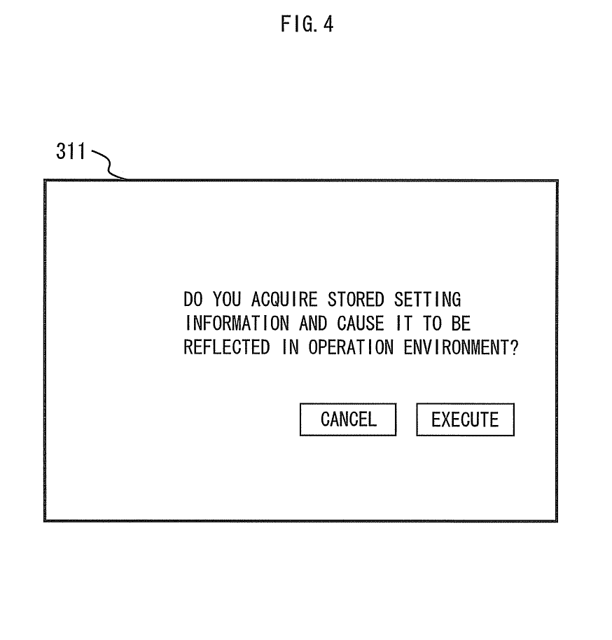

When acquiring the notification informing the authentication success from the authentication section 12, the setting request acquisition section 31 configures a request screen (for example, a request screen 311 as in FIG. 4) to urge an input as to whether or not a request is made for reflection of the setting contents based on the setting information into the operation environment, and displays it on the display 101c (the request is called the setting request in the present specification). Next, the setting request acquisition section 31 uses the request screen 311 and acquires the setting request from the user. Next, the setting request acquisition section 31 sends the notification, which informs the acquisition of the setting request, to the setting information acquisition section 14.

When acquiring the notification to inform the acquisition of the setting request from the setting request acquisition section 31, the setting information acquisition section 14 uses the specific information acquired from the specific information acquisition section 13 and acquires the setting information.

Here, in the first embodiment, when the setting information acquisition section 14 determines from the acquired specific information that the setting information is stored in the storage area 101b as its own storage area, the setting information acquisition section acquires the setting information from the storage area 101b.

On the other hand, there is also a case where the setting information acquisition section 14 determines from the acquired specific information that the setting information is stored in a storage area of another MFP. A description will be given to, as an example, a case where the specific information indicates the storage area 102b of the MFP 102. In this case, the setting information acquisition section 14 sends a command to request the setting information to the MFP 102 including the storage area 102b through the network. The setting information acquisition section 14 acquires the setting information corresponding to the specific information from the storage area 102b of the MFP 102.

Incidentally, in the first embodiment, there is a case where the setting information acquisition section 14 can not acquire the notification to inform the acquisition of the setting request from the setting request acquisition section 31. Besides, there is also a case where the setting information acquisition section 14 can not acquire the specific information from the specific information acquisition section 13. Further, there is also a case where as a result of execution of acquisition of the setting information, the setting information cannot be acquired. In these cases, the setting information acquisition section 14 acquires the initial setting information from the storage area 101b and sends it to the setting reflection section 15.

The setting reflection section 15 causes the setting contents based on the setting information acquired by the setting information acquisition section 14 to be reflected in the operation environment of the user in the MFP 101. Since the setting contents based on the setting information are reflected in the operation environment of the user, the user can use an address book, a user template, a screen layout and the like, which are previously set in another MFP, also in the MFP 101.

Besides, in the first embodiment, when acquiring the initial setting information from the setting information acquisition section 14, the setting reflection section 15 uses the initial setting information, and causes the previously set initial setting contents of the operation environment to be reflected in the operation environment of the user. In other words, when the specific information acquisition section 13 can not acquire the specific information, or the setting information acquisition section 14 cannot acquire the setting information or can not acquire the request from the user for the reflection of the setting contents based on the setting information, the setting reflection section 15 causes the previously set initial setting contents of the operation environment to be reflected in the operation environment of the user.

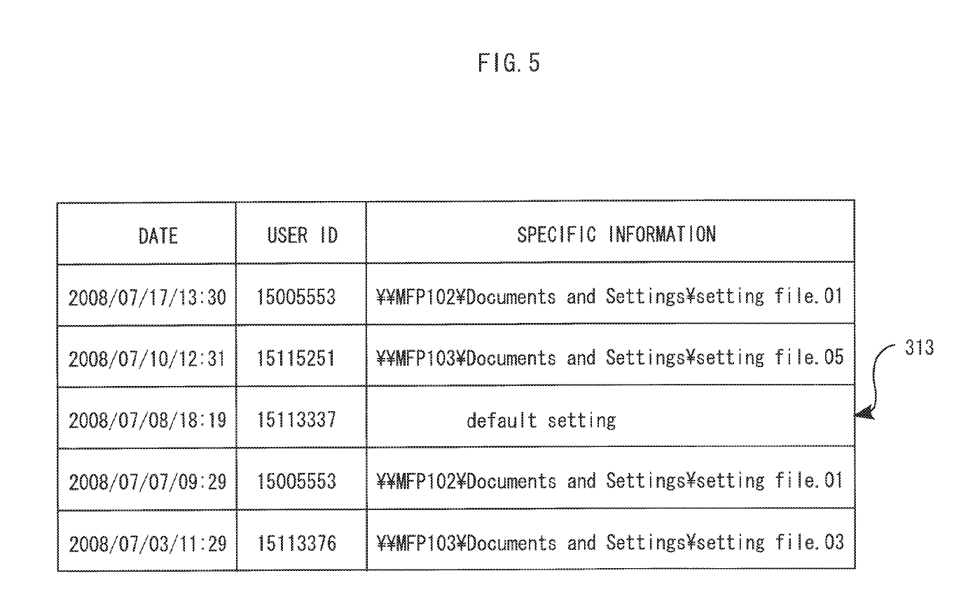

Then, the setting reflection section 15 causes the information about the setting contents, which are reflected in the operation environment of the user, to be stored as the setting log information in the storage area 101b. Specifically, when the setting contents based on the setting information for each user are reflected in the operation environment of the user, the specific information used for acquiring the setting information, the user ID of the user relating to the setting information, and the date when the reflection process is executed are correlated with each other as in FIG. 5 and are stored in the form of the data table. Besides, in the data table shown in FIG. 5, when the initial setting contents are reflected in the operation environment of the user, instead of the specific information, information 313 indicating that the operation environment is based on the initial setting contents is correlated with the user ID and the date and is stored.

Here, there is a case where another MFP in which the setting information is stored and the MFP 101 as the setting object are different from each other in function. For example, there is a case where although another MFP has a FAX communication function, the MFP 101 does not have the FAX communication function.

In this case, the setting reflection section 15 causes the setting contents based on, in the information included in the setting information, only information about functions provided in the MFP 101 to be reflected in the operation environment of the user.

Besides, there is also a case where although the MFP 101 has the FAX communication function, the another MFP storing the setting information does not have the FAX communication function, and accordingly, information about the setting of the operation environment relating to the FAX communication function is not included in the setting information. In such a case, with respect to the functions provided in the MFP 101, the setting reflection section 15 causes the setting contents based on the acquired setting information to be reflected in the operation environment. Besides, with respect to the function not included in the setting information, for example, with respect to the FAX function, the setting reflection section 15 causes the initial setting contents in the MFP 101 to be reflected in the operation environment. In this case, specifically, the setting reflection section 15 sends a command to request the acquisition of the initial setting information from the storage area 101b to the setting acquisition section 14. The setting acquisition section 14 acquires the initial setting information from the storage area 101b, and sends it to the setting reflection section 15. The setting reflection section 15 uses the acquired initial setting information, and causes the initial setting contents to be reflected in the operation environment of the user relating to the FAX communication function.

Next, the function block relating to the change of setting of the operation environment will be described.

When acquiring the request for the change of setting of the operation environment in the MFP 101, which is inputted by the user through the operation section 101d, the setting change section 41 changes the setting of the operation environment, which is set in the MFP 101. Then, the setting change section 41 sends a notification, which informs the change of the setting, to the information generation section 42.

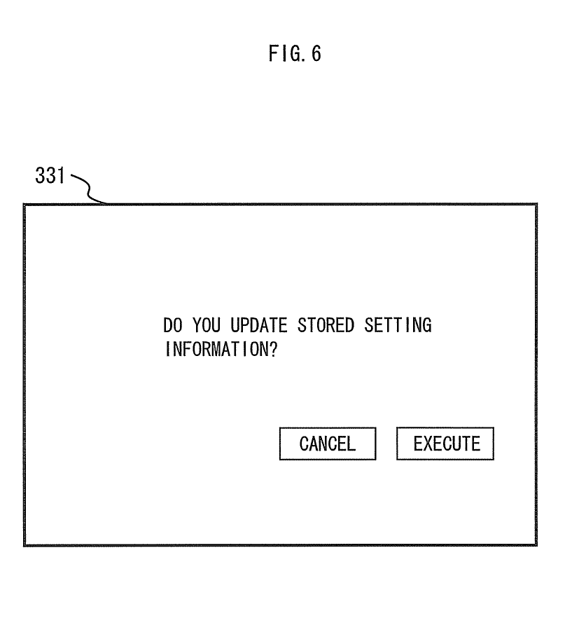

When acquiring the notification to inform the change of the setting from the setting change section 41, the update request acquisition section 33 acquires the setting log information from the storage area 101b, and determines whether the setting contents based on the setting information specific to each user are reflected in the setting of the operation environment in which the change is performed. When the setting contents based on the setting information are reflected, the update request acquisition section 33 configures a request screen (for example, a request screen 331 as in FIG. 6) to urge an input as to whether or not a request is made for update of the stored setting information and displays it on the display 101c. Next, the update request acquisition section 33 uses the request screen 331, and acquires the request for the update (hereinafter referred to as the update request) from the user. Next, the update request acquisition section 33 sends a notification, which informs the acquisition of the update request, to the setting information acquisition section 14.

When acquiring the notification to inform the acquisition of the update request, the information generation section 42 configures information (hereinafter referred to as change information) about the specific contents of the setting in which the change is performed, and sends it, together with the setting log information, to the update section 43.

When acquiring the change information from the information generation section 42, the update section 43 updates the setting information, which is used for the setting of the operation environment of the MFP 101, to a state where the change content is reflected (for example, part of or all of data about the setting information is overwritten). In other words, when acquiring the change information from the information generation section 42, the update section 43 updates the setting information, which is stored in the storage area at the location indicated by the specific information, to the state where the change content is reflected.

Specifically, the update section 43 uses the specific information stored in the setting log information, and sends a command to request the update of the setting information, together with the change information, to the MFP including the storage area indicated by the specific information through the network. Then, when acquiring the command to request the update, the MFP 102 updates the setting information stored in the storage area 102b based on the simultaneously acquired change information, so that the state where the change content is reflected is obtained.

Besides, there is also a case where the setting information is stored in the storage area 101b. At this time, the update section 43 uses the change information, and executes the update to obtain the state where the change content is reflected in the setting information stored in the storage area 101b.

Incidentally, in the present specification, the reflection of the setting contents based on the setting information into the operation environment of the user is the concept including a case where the initial setting contents are reflected for a part of the functions.

Next, the process flow relating to the reflection of the setting contents based on the setting information into the operation environment of the user will be described in detail.

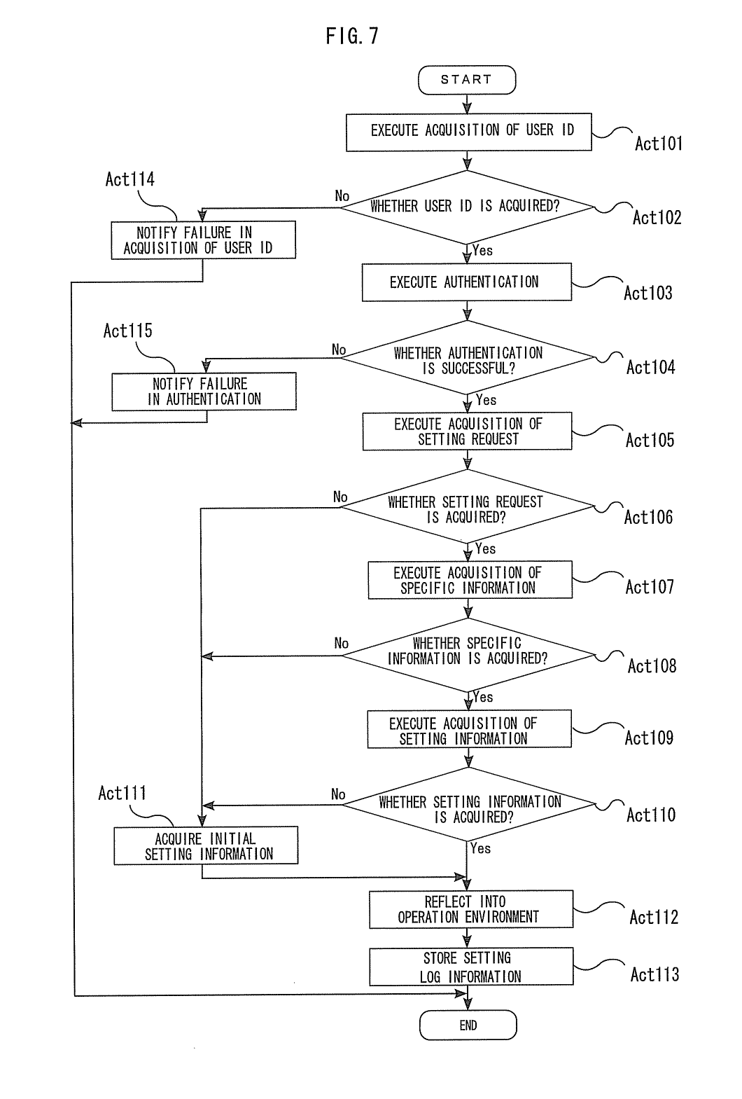

As shown in FIG. 7, at Act 101, the authentication information acquisition section 11 executes acquisition of the user ID acquired from the IC card 113 by the authentication card reader 111. Next, the authentication information acquisition section 11 determines whether the user ID could be acquired (Act 102). When the user ID can not be acquired, advance is made to Act 114, and the authentication information acquisition section 11 uses, for example, the display 101c, and notifies the user of the acquisition failure of the user ID. On the other hand, when it is determined that the user ID was acquired, the authentication information acquisition section 11 sends the user ID to the authentication section 12 and the setting reflection section 15.

At Act 103, the authentication section 12 uses the acquired user ID and executes the authentication process. Next, at Act 104, the authentication section 12 determines whether or not the authentication is successful. When the authentication is failed, advance is made to Act 115, and the authentication section 12 uses, for example, the display 101c and notifies the user of the authentication failure. On the other hand, when the authentication is successful, the authentication section 12 sends the notification indicating the authentication success to the setting request acquisition section 31.

At Act 105, when acquiring the notification indicating the authentication success, the setting request acquisition section 31 configures the request screen 311 to display it on the display 101c, and execute acquisition of a setting request from the user. Next, at Act 106, the setting request acquisition section 31 determines whether the setting request from the user could be acquired. When the setting request from the user could be acquired, the setting request acquisition section 31 sends the notification, which informs that the setting request from the user could be acquired, to the setting information acquisition section 14. On the other hand, when the setting request from the user can not be acquired, the setting request acquisition section 31 sends the notification, which indicates that the setting request from the user could not be acquired, to the setting information acquisition section 14.

At Act 107, the specific information acquisition section 13 executes acquisition of the specific information acquired by the authentication card reader 111 from the IC card 113 from which the user ID was acquired. The specific information acquisition section 13 determines whether the specific information could be acquired (Act 108). When the specific information could be acquired, the specific information acquisition section 13 sends the specific information to the setting information acquisition section 14 and the setting reflection section 15. On the other hand, when the specific information can not be acquired, the specific information acquisition section 13 sends the notification, which informs that the specific information could not be obtained, to the setting information acquisition section 14.

At Act 109, the setting information acquisition section uses the acquired specific information and executes acquisition of the setting information. Then, at Act 110, the setting information acquisition section 14 determines whether the setting information could be acquired. When the setting information could be acquired, the setting information acquisition section 14 sends the setting information to the setting reflection section 15. On the other hand, when the setting information could not be acquired, the setting information acquisition section 14 advances to Act 111, acquires the initial setting information from the storage area 101b, and sends it to the setting reflection section 15.

Besides, when acquiring the notification to inform that the setting request can not be acquired and when acquiring the notification to inform that the specific information can not be acquired, the setting information acquisition section 14 acquires the initial setting information from storage area 101b at Act 111. Then, the setting information acquisition section 14 sends the acquired initial setting information to the setting reflection section 15.

Act 112, the setting reflection section 15 uses the acquired setting information or the initial setting information, and causes the setting contents indicated thereby to be reflected in the operation environment of the user in the MFP 101. Then, at Act 113, the setting reflection section 15 correlates the specific information, the user ID and the date of execution of the reflection process with each other, and stores them as the setting log information in the storage area 101b.

Next, the process relating to the acquisition of the setting information at Act 109 will be described in detail with reference to FIG. 7.

First, at Act 1091, the setting information acquisition section 14 determines whether or not the storage area indicated by the specific information is the storage area 101b. When the storage area indicated by the specific information is the storage area 101b, the setting information acquisition section 14 advances to Act 1092, and acquires the setting information from the storage area 101b. On the other hand, when the storage area indicated by the specific information is not the storage area 101b, the setting information acquisition section 14 execute acquisition of the setting information from a storage area different from the storage area 101b. Specifically, a command to request the setting information is sent through the network to the MFP (for example, the MFP 102) including the storage area indicated by the specific information. Then, the setting information acquisition section 14 advances to Act 110, and determines whether the setting information could be acquired.

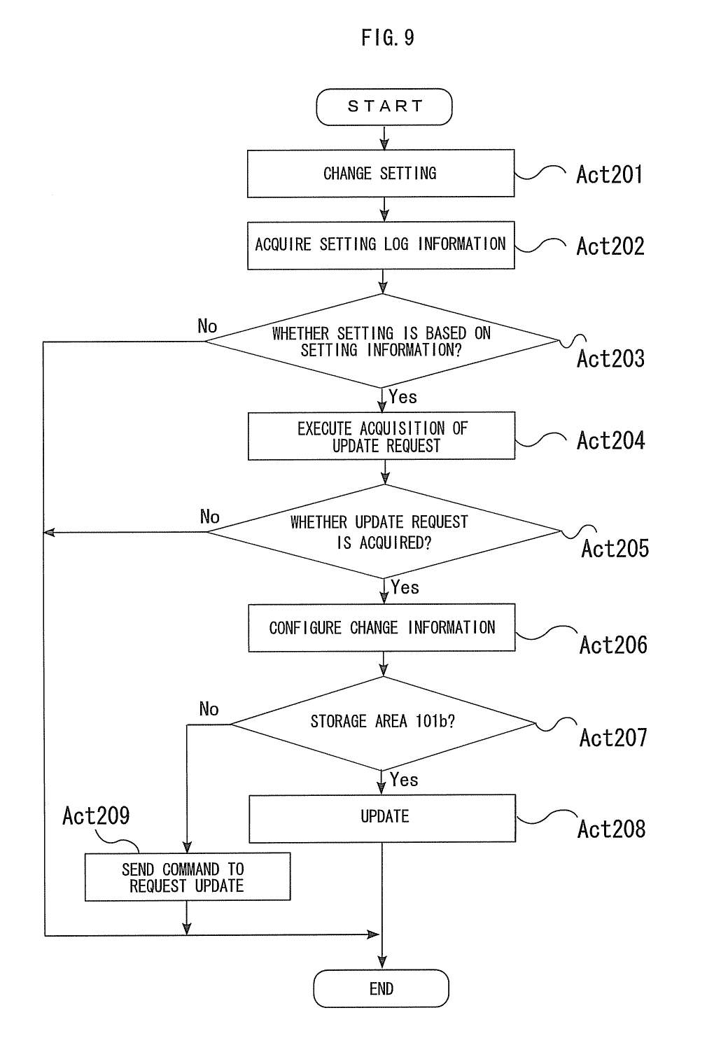

Next, the process flow in a case where the change of the operation environment set in the MFP 101 is inputted will be described in detail with reference to FIG. 9.

At Act 201, when acquiring the request for the change of the setting of the operation environment in the MFP 101, which is inputted by the user through the operation section 101d, the setting change section 41 changes the setting of the operation environment set in the MFP 101. Then, the setting change section 41 sends a notification, which informs that the change of the setting was performed, to the update request acquisition section 33.

At Act 202, when acquiring the notification to inform that the change of the setting was performed, the update request acquisition section 33 acquires the setting log information from the storage area 101b. Next, at Act 203, the update request acquisition section 33 determines, based on the acquired setting log information, whether or not the setting contents based on the setting information are reflected in the operation environment in which the setting was changed. When the setting contents based on the setting information are not reflected, in other words, when the initial setting contents are reflected in the operation environment, the information generation section 42 ends the process without executing the acquisition of the update request.

On the other hand, there is also a case where it is determined that the change of the setting is performed for the operation environment in which the setting contents based on the setting information are reflected. In this case, the update request acquisition section 33 advances to Act 204, configures the request screen 331 to display it on the display 101c, and executes acquisition of the update request from the user. Next, at Act 205, the update request acquisition section 33 determines whether the update request from the user could be acquired. When the update request from the user could be acquired, the update request acquisition section 33 sends a notification, which informs that the update request from the user could be acquired, to the information generation section 42. On the other hand, when the update request from the user can not be acquired, the update request acquisition section 33 sends a notification, which informs that the update request from the user could not be acquired, to the information generation section 42.

When acquiring the notification to inform that the update request from the user could not be acquired, the information generation section 42 configure the change information at Act 206 and sends it, together with the setting log information, to the update section 43.

When acquiring the change information and the setting log information, the update section 43 performs update based on the specific information included in the setting log information, so that the change content is reflected in the setting information stored in the storage area indicated by the specific information. Specifically, at Act 207, the update section 43 determines whether the setting information is stored in the storage area 101b. When the setting information is stored in the storage area 101b, the update section 43 advances to Act 208, and updates the stored setting information by using the change information. On the other hand, when the setting information is stored in a storage area of another MFP, the update section 43 advances to Act 209, and sends a command to request the update of the setting information, together with the change information, to the MFP through the network based on the specific information included in the setting log information.

According to the first embodiment as described above, it is not necessary to provide a management apparatus to collectively store the setting information, and the setting contents of the operation environment set in an apparatus can be reflected in another different apparatus.

Besides, according to the first embodiment, when the setting contents based on the setting information stored in an apparatus are reflected in another apparatus, and the setting reflected in the another apparatus is changed, the change content can be reflected in the stored setting information. Accordingly, the labor that the user updates the setting information can be omitted.

### Second Embodiment

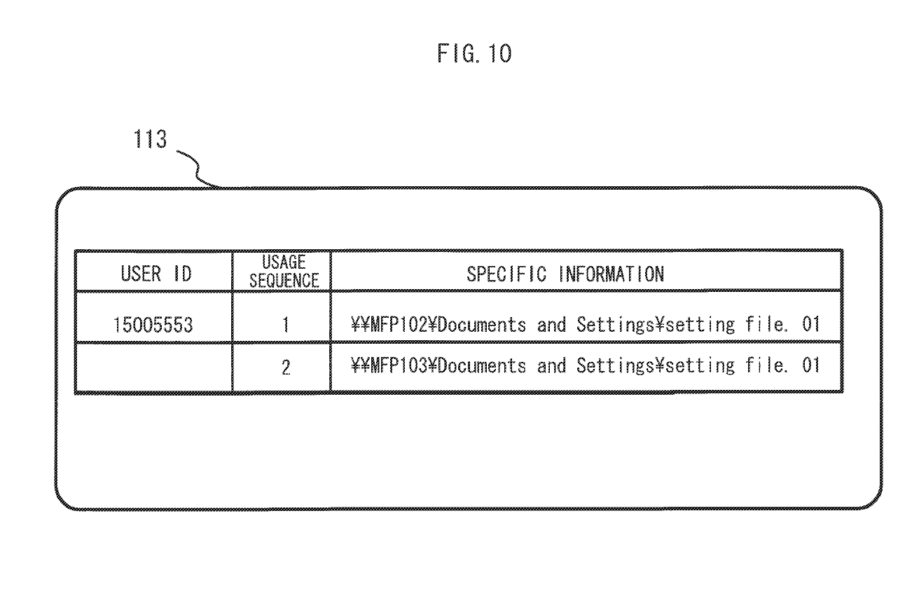

In the first embodiment, the user can store one piece of setting information in the previously specified one MFP. On the other hand, in a second embodiment of the invention, the user can store the setting information in plural MFPs. As exemplified as a data table in FIG. 10, one or more pieces of specific information (two in FIG. 10) correlated with one piece of authentication information are stored in an IC card 113 owned by the user. The MFP 101 can acquire arbitrary one or more pieces of specific information from the IC card 113. Besides, similarly to the first embodiment, the MFP 101 acquires the setting information based on the acquired specific information. However, when arbitrary plural pieces of specific information are acquired, and when the setting information can not be acquired from a storage area at a location indicated by one (first specific information) of the acquired plural pieces of specific information, the MFP acquires the setting information based on another piece of specific information (second specific information) indicating a location different from that of the first specific information.

Besides, in the second embodiment, when the MFP 101 acquires plural pieces of specific information, and when the setting of the operation environment is changed, the respective pieces of setting information stored in the storage areas indicated by the plural pieces of specific information are updated to the states where the changed setting contents are reflected.

Hereinafter, a description will be given to a block structure about functions of the MFP 101 of the second embodiment, which relate to the reflection of the setting contents based on the acquired setting information into the operation environment, and the change of setting of the operation environment. In the second embodiment, the function block diagram is common to that of the first embodiment. Besides, a component common to that of the first embodiment is denoted by the same symbol and its description will be omitted.

Similarly to the first embodiment, a specific information acquisition section 13 acquires specific information acquired from an IC card 113 by an authentication card reader 111 attached to the MFP 101, and sends it to a setting information acquisition section 14 and a setting reflection section 15. Here, in the second embodiment, as shown in FIG. 10, the IC card 113 has one or more pieces of specific information. In addition, in the second embodiment, information (hereinafter referred to as acquisition prescription information) relating to the prescription at the time of acquisition of the setting information by the setting information acquisition section 14 is correlated with the user ID and the specific information and is stored. FIG. 10 exemplifies a case where the usage sequence of the specific information at the time of acquisition of the setting information is prescribed as the acquisition prescription information. The specific information acquisition section 13 acquires one or more pieces of specific information acquired by the authentication card reader 111, and sends them to the setting information acquisition section 14 and the setting reflection section 15. Further, the specific information acquisition section 13 acquires the acquisition prescription information and sends it to the setting information acquisition section 14.

When receiving a notification indicating that the setting request from a setting request acquisition section 31 was acquired, the setting information acquisition section 14 uses one or more pieces of specific information acquired from the specific information acquisition section 13 and the acquisition prescription information, and acquires the setting information from the storage area 101b of the MFP 101 or a storage area of another MFP connected through a network.

Here, in the second embodiment, when the plural pieces of setting information are acquired, and when the setting information acquisition section 14 can not acquire the setting information from the storage area at the location indicated by one (first specific information) of the acquired plural pieces of specific information, the setting information acquisition section acquires the setting information based on another specific information (second specific information) indicating a location different from that of the first specific information.

With respect to the acquisition of the setting information by the setting information acquisition section 14 of the second embodiment, a more detailed description will be made while using, as an example, a case where two pieces of specific information are acquired, and information about the sequence used for the execution of the setting information acquisition is acquired as the acquisition prescription information.

In this case, the setting information acquisition section 14 first uses the specific information (for example, specific information indicating the storage area 102b of the MFP 102) which is the first in the sequence prescribed in the acquisition prescription information and used for the execution of the setting information acquisition, and sends a command, which requests the setting information, to the MFP 102 including the storage area indicated by the specific information through the network. The setting information acquisition section 14 acquires the setting information from the storage area 102b of the MFP 102.

On the other hand, when the setting information could not be acquired from the MFP 102, the setting information acquisition section 14 uses the specific information (for example, the specific information indicating the storage area 103b of the MFP 103) which is the second in the sequence used for the execution of the setting information acquisition, and executes acquisition of the setting information. Specifically, a command, which requests the setting information, is sent through the network to the MFP 103 including the storage area indicated by the specific information. Then, the setting information acquisition section 14 acquires the setting information from the storage area 103b of the MFP 103.

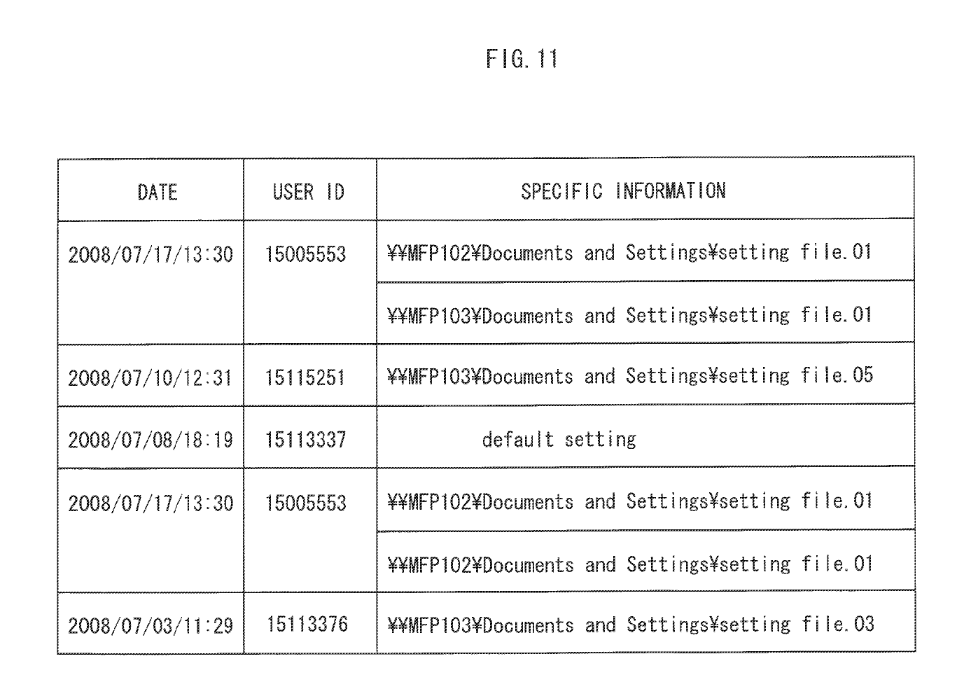

Similarly to the first embodiment, the setting reflection section 15 causes the setting contents based on the setting information or the initial setting contents to be reflected in the operation environment of the user. Besides, in the second embodiment, when acquiring plural pieces of specific information from the specific information acquisition section 13, the setting reflection section 15 correlates the plural pieces of setting information with the user ID as exemplified in FIG. 11, and store them as the setting log information in the storage area 101b.

Besides, similarly to the first embodiment, when acquiring change information from an information generation section 42, an update section 43 updates the setting information stored in the storage area at the location indicated by the specific information to a state where the change content is reflected. Here, in the second embodiment, there is also a case where the update section 43 acquires plural pieces of specific information. In this case, the update section 43 updates the respective pieces of setting information stored in the storage areas indicated by the plural pieces of specific information to the states where the changed setting contents are reflected.

Specifically, when acquiring the change information from the setting change section 41, the update section 43 sends a command, which requests update of the setting information, together with the change setting information, to the respective MFPs including the storage areas indicated by the plural pieces of specific information through the network. When receiving the command to request the update, the respective MFPs update the setting information stored in the respective storage areas by using the simultaneously acquired change information.

Incidentally, there is also a case where the plural pieces of specific information include information indicating the storage area 101b. At this time, the update section 43 sends the command to request the update, together with the change information, to another MFP as described above, and uses the change information to update the setting information stored in the storage area 101b.

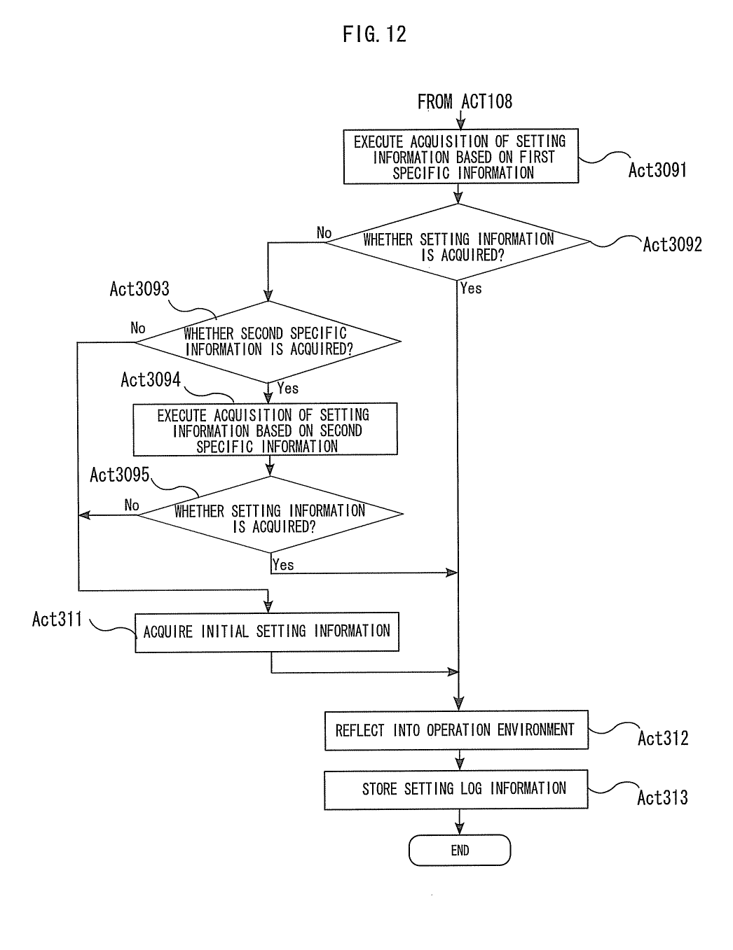

Next, the process flow from the authentication of the user to the reflection of the setting contents into the operation environment will be described with reference to FIG. 12.

Incidentally, a flow other than the process relating to the execution of the acquisition of the setting information is common to that of the first embodiment described in FIG. 7 except that plural pieces of specific information are acquired and the acquisition prescription information, together with the specific information, is acquired, and therefore, its description is omitted.

First, it is assumed that it is determined at Act 108 of FIG. 7 that the specific information acquisition section acquires the specific information, and it is determined at Act 106 that the setting request acquisition section 31 acquires the setting request.

At this time, at Act 3091, the setting information acquisition section 14 uses the first specific information which is prescribed to be used first for the setting information acquisition in the acquisition prescription information, and acquires the setting information. Incidentally, since the specific process relating to the acquisition of the setting information from the storage area indicated by the specific information is common to that of the first embodiment, its description is omitted.

Next, at Act 3092, the setting information acquisition section 14 determines whether the setting information could be acquired from the storage area indicated by the first specific information. When the setting information could be acquired, the setting information acquisition section 14 sends the acquired setting information to the setting reflection section 15.

On the other hand, there is also a case where it is determined that the setting information can not be acquired from the storage area indicated by the first specific information. At this time, the setting information acquisition section 14 advances to Act 3093, and determines whether the specific information (second specific information), which is prescribed to be used second for the setting information acquisition in the acquisition prescription information and is different from the first specific information, is acquired. When the second specific information is not acquired, the setting information acquisition section 14 advances to Act 311, acquires the initial setting information from the storage area 101b, and sends it to the setting reflection section 15.

On the other hand, when the second specific information is acquired, the setting information acquisition section 14 uses the second specific information, and executes acquisition of the setting information (Act 3094). Next, at Act 3095, the setting information acquisition section 14 determines whether the setting information could be acquired from the storage area indicated by the second specific information. When the setting information could be acquired, the setting information acquisition section 14 sends the setting information to the setting reflection section 15.

On the other hand, when the setting information can not be acquired from the storage area indicated by the second specific information, the setting information acquisition section 14 advances to Act 311, acquires the initial setting information from the storage area 101b, and sends it to the setting reflection section 15.

Act 312, the setting reflection section 15 uses the acquired setting information or the initial setting information, and causes the setting contents indicated thereby to be reflected in the operation environment of the user in the MFP 101. Then, at Act 313, the setting reflection section 15 correlates the specific information, the user ID and the date of execution of the reflection process with each other, and stores them as the setting log information in the storage area 101b. At this time, when plural pieces of specific information are acquired from the setting reflection section 15, the plural pieces of specific information are correlated with the user ID and are stored in the storage area 101b.

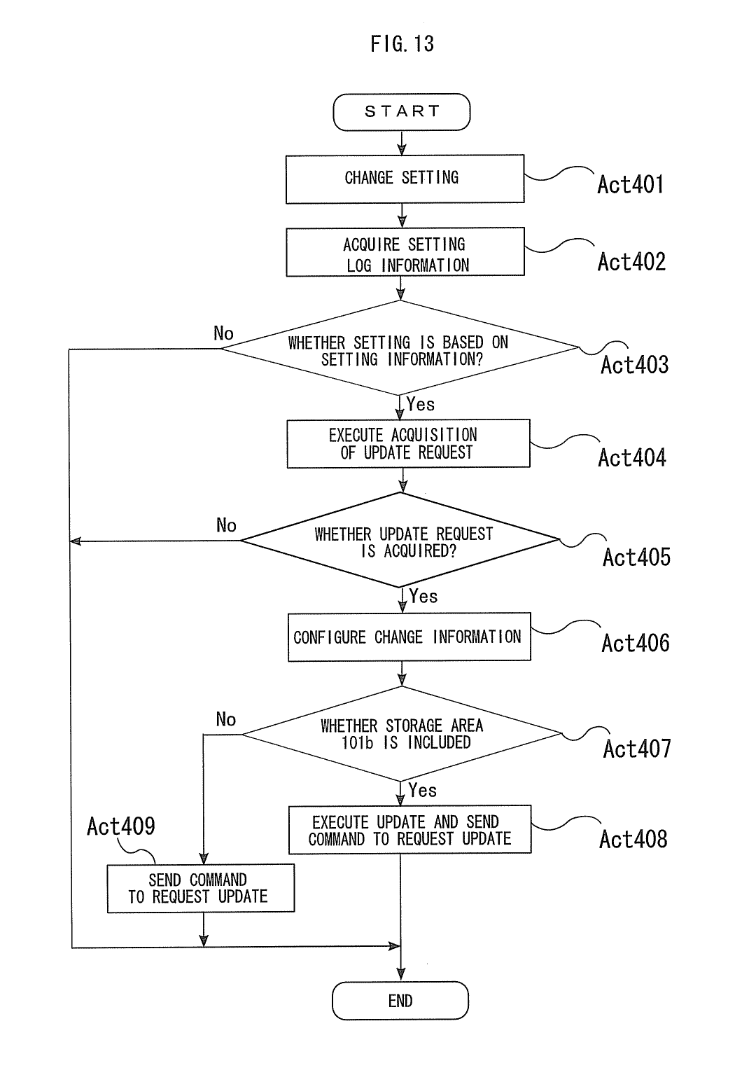

Next, the process flow in a case where the change of the operation environment set in the MFP 101 is inputted will be described in detail with reference to FIG. 13.

Incidentally, since the process flow from Act 401 to Act 406 in FIG. 13 is common to the process flow from Act 201 to Act 206 in FIG. 9 of the first embodiment, its description is omitted.

In the following description, it is assumed that the specific information acquisition section 13 acquires plural pieces of specific information, and the plural pieces of specific information are correlated with the user ID and are stored in the setting log information.

In the second embodiment, the update section 43 which acquires the change information and the setting log information uses plural pieces of specific information included in the setting log information, and updates the setting information stored in the respective storage areas to the state where the changed setting contents are reflected. Specifically, the update section 43 determines whether the plural pieces of specific information included in the setting log information include the specific information indicating the storage area 101b (Act 407). When the specific information indicating the storage area 101b is included, the update section 43 advances to Act 408, and updates the setting information stored in the storage area 101b by using the change information. Further, the update section 43 sends a command which requests update of the setting information, together with the change information, to the MFP including the storage area indicated by the specific information through the network. On the other hand, there is also a case where it is determined that the acquired plural pieces of specific information do not include the specific information indicating the storage area 101b. At this time, the update section 43 advances to Act 409, sends a command which requests update of the setting information, together with the change information, to the MFP including the storage area indicated by the specific information through the network.

According to the second embodiment described above, the setting information is enabled to be acquired from one of the plural storage areas. Thus, even if the acquisition of the setting information from a storage area is failed, the acquisition of the setting information from another storage area can be again executed. Accordingly, according to the second embodiment, when the setting information is acquired, it is possible to reduce the influence of the state of the network connection.

Besides, when the setting of the operation environment is changed, the setting information stored in plural storage areas are updated according to the change, so that the setting information stored in the plural storage areas can be brought into the state where the change is reflected. By this, any apparatus including the storage area storing the setting information can use the operation environment in which the change is reflected.

### Third Embodiment

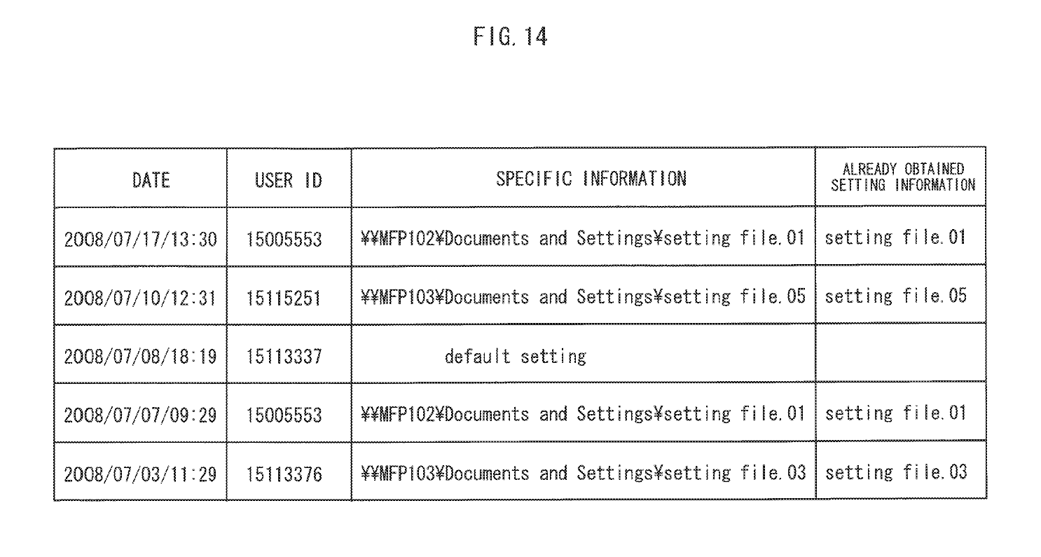

In the first and the second embodiments, the MFP 101 correlates the specific information used for acquisition of the setting information with the user ID, and stores them as the setting log information. In a third embodiment, for example, as shown in FIG. 14, the MFP 101 correlates the acquired setting information with the specific information and the user ID, and stores them as the setting log information in the storage area 101b (hereinafter, the setting information stored as the setting log information is referred to as the already obtained setting information). When the specific information indicates a storage area included in another MFP and the setting information can not be acquired from the MFP including the storage area indicated by the specific information, the MFP 101 uses the already obtained setting information stored in the storage area 101b, and sets the operation environment of the user.

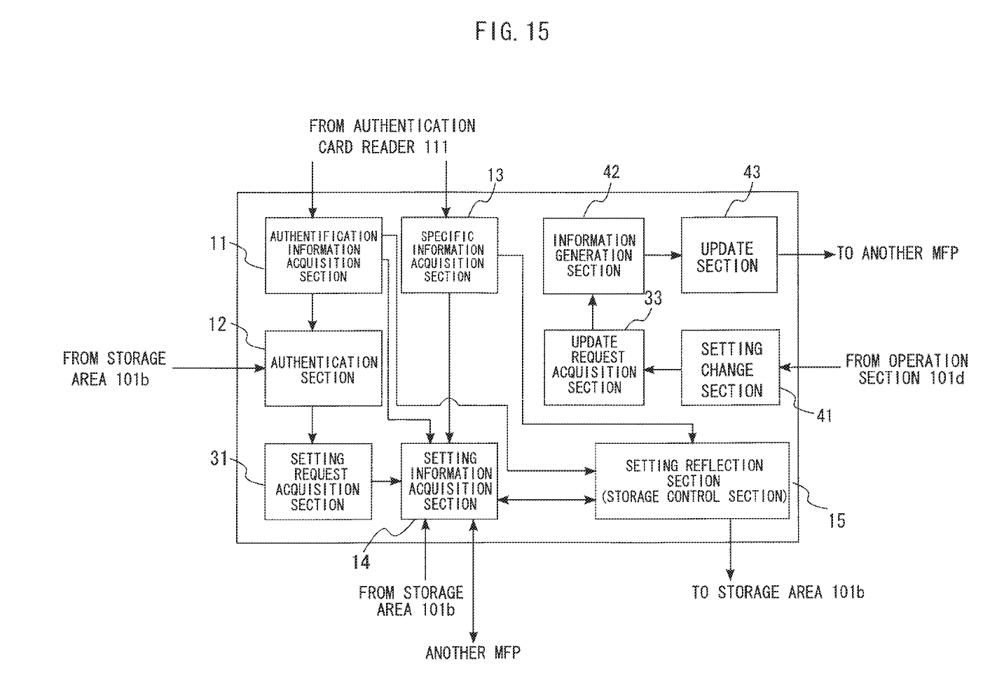

Hereinafter, a block structure about functions of the MFP 101 of the third embodiment, which relate to the acquisition of the setting information and the setting of the operation environment based on the acquired setting information, will be described with reference to FIG. 15. A component common to the first embodiment is denoted by the same symbol and its description is omitted.

Similarly to the first embodiment, when acquiring the setting information, a setting reflection section 15 causes the setting contents indicated by the setting information to be reflected in the operation environment of the user in the MFP 101. Besides, in the third embodiment, when acquiring the setting information, the setting reflection section 15 correlates the setting information with the user ID, the specific information and the date of execution of the reflection process, and stores them as the setting log information in the storage area 101b (see FIG. 14). That is, in the third embodiment, the setting reflection section 15 corresponds to also the storage control section in addition to the setting reflection section.

Incidentally, in the third embodiment, there is also a case where the setting reflection section 15 acquires the already obtained setting information and the initial setting information instead of the setting information as described later. In this case, the already obtained setting information and the initial setting information are not stored as the setting log information. When the already obtained setting information and the initial setting information are acquired, in the data table exemplified in FIG. 14, a column relating to the already obtained setting information is expressed as a blank column.

Similarly to the first embodiment, a setting information acquisition section 14 acquires the setting information from the storage area 101b of the MFP 101 or a storage area included in another MFP, and sends it to the setting reflection section 15. Besides, also in the third embodiment, similarly to the first embodiment, there is a case where a specific information acquisition section 13 cannot acquire the specific information, or the setting information acquisition section 14 can not acquire the setting information. At this time, the setting information acquisition section 14 acquires the already obtained setting information when the already obtained setting information is stored in the storage area 101b, or acquires the initial setting information from the storage area 101b when the already obtained setting information is not stored. The setting information acquisition section 14 sends the acquired already obtained setting information or the initial setting information to the setting reflection section 15.

In the third embodiment, the authentication information acquisition section 11 sends the user ID to the setting information acquisition section 14 in addition to the authentication section 12 and the setting reflection section 15. The setting information acquisition section 14 uses one of the specific information and the user ID, and specifies the already obtained setting information stored in the storage area 101b and corresponding to the authenticated user (in other words, the acquired user ID).

Incidentally, there is also a case where plural pieces of already obtained setting information corresponding to one user (one user ID or one piece of specific information) are stored. In such a case, for example, the setting information acquisition section 14 can acquire the newest already obtained setting information according to the correlated date of execution of the reflection process.

Besides, in the third embodiment, in addition to the case where the setting information is acquired described above, also when the already obtained setting information is acquired, the setting reflection section 15 causes the setting contents based on the already obtained setting information to be reflected in the operation environment of the user in the MFP 101.

Further, when neither the setting information nor the already obtained setting information can be acquired, the setting reflection section 15 acquires the initial setting information similarly to the first embodiment, uses the initial setting information and causes the initial setting contents to be reflected in the operation environment of the user.

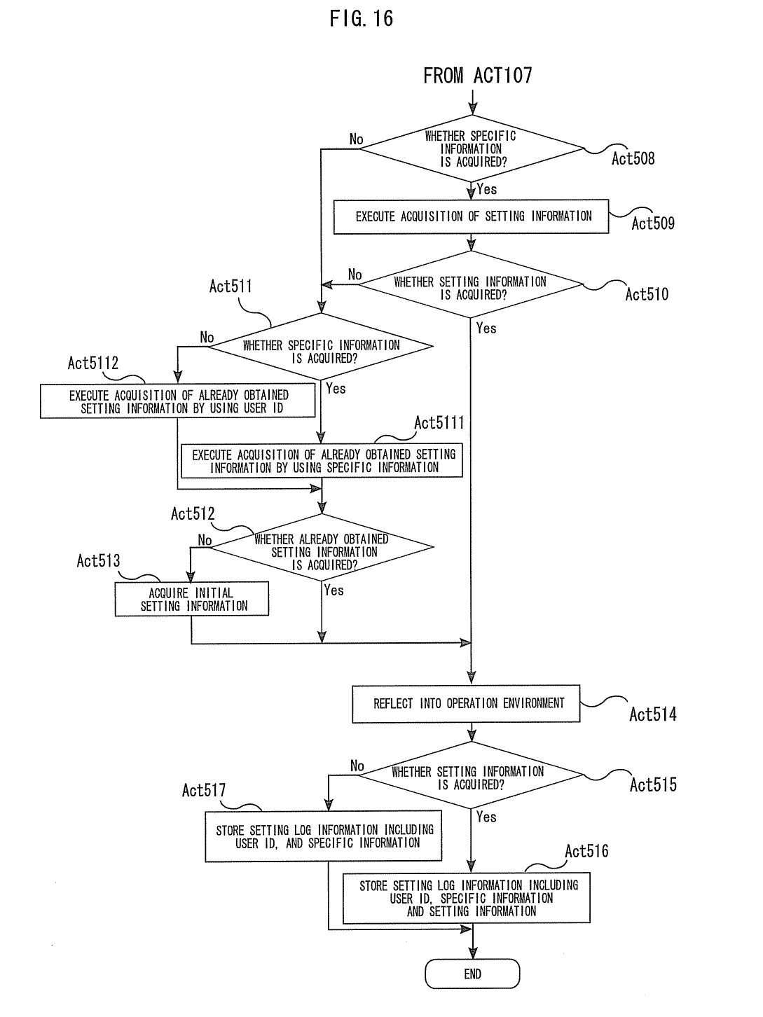

Next, a process flow in the third embodiment will be described with reference to FIG. 16.

In the third embodiment, since a process flow in a case where the change of setting of the operation environment in the MFP 101 is inputted is common to that of the first embodiment, its description is omitted.

Besides, also in a process flow relating to the acquisition of the setting information and the reflection of the setting contents based on the setting information into the operation environment in the MFP 101 described below, the process from the acquisition of the user ID to the execution of acquisition of the specific information is common to that of the first embodiment except that the user ID acquired by the authentication information acquisition section 11 is sent also to the setting information acquisition section 14, and therefore, its description is omitted.

First, it is assumed that it is determined at Act 106 in FIG. 7 that a setting request acquisition section 31 acquires a setting request, and the specific information acquisition section 13 executes acquisition of the specific information at Act 107.

At this time, at Act 508, the specific information acquisition section 13 determines whether the specific information could be acquired. When determining that the specific information could be acquired, the specific information acquisition section 13 sends the acquired specific information to the setting information acquisition section 14 and the setting reflection section 15. Next, at Act 509, the setting information acquisition section 14 executes acquisition of the setting information based on the acquired specific information. At Act 510, the setting information acquisition section 14 determines whether the setting information could be acquired. When the setting information could be acquired, the setting information acquisition section 14 sends the acquired setting information to the setting reflection section 15.

On the other hand, at Act 508, there is a case where the specific information acquisition section 13 determines that the specific information can not be acquired, and the specific information acquisition section 13 sends the notification, which informs that the specific information can not be acquired, to the setting information acquisition section 14. Besides, at Act 510, there is also a case where it is determined that the setting information section 14 can not acquire the setting information. At this time, at Act 511, the setting information acquisition section 14 determines whether the specific information is acquired. When it is determined that the specific information was acquired, the setting information acquisition section 14 uses the acquired specific information and executes acquisition of the already obtained setting information from the storage area 101b (Act 5111). On the other hand, when it is determined that the specific information is not acquired, the setting information acquisition section 14 uses the acquired user ID and executes acquisition of the already obtained setting information from the storage area 101b (Act 5112).

At Act 512, the setting information acquisition section 14 determines whether the already obtained setting information could be acquired. When the already obtained setting information could be acquired, the setting information acquisition section 14 sends the already obtained setting information to the setting reflection section 15. On the other hand, when the already obtained setting information can not be acquired (for example, when the already obtained setting information corresponding to the user ID of the authenticated user is not stored in the storage area 101b), the setting information acquisition section 14 acquires the initial setting information from the storage area 101b and sends it to the setting reflection section 15 (Act 513).

At Act 514, the setting reflection section 15 uses one of the acquired setting information, the already obtained setting information and the initial setting information, and causes the setting contents to be reflected in the operation environment of the user in the MFP 101. Next, at Act 515, the setting reflection section 15 determines whether the setting information is acquired. When it is determined that the setting information is acquired, advance is made to Act 516, and the setting reflection section 15 causes the setting log information including the setting information in addition to the user ID and the specific information to be stored in the storage area 101b. The setting information included in the setting log information corresponds to the already obtained setting information.

On the other hand, when it is determined that the setting information is not acquired, in other words, when the setting reflection section 15 acquires the already obtained setting information or the initial setting information, at Act 517, similarly to the first embodiment, the setting reflection section causes the setting log information including the user ID and the specific information to be stored in the storage area 101b.

According to the third embodiment described above, since the setting contents based on the already obtained setting information stored in the storage area 101b can be reflected in the operation environment, even when the setting information can not be acquired, the operation environment in which the operation can be more easily performed as compared with the initial setting can be provided to the user.

Incidentally, in the third embodiment, for facilitating the understanding, the description is given to the example in which the already obtained setting information or the initial setting information is not stored as the setting log information. However, no limitation is made to this, and it would be understood for one skilled in the art that the already obtained setting information or the initial setting information may be stored as the setting log information.

### Fourth Embodiment

In the first to the third embodiments, the MFP 101 causes the setting contents based on the setting information stored in the storage area 101b or the setting information acquired through the network to be reflected in the operation environment of the user. Besides, the IC card 113 is used for authentication of the user in the MFP such as the MFP 101, and the specific information indicating the storage area where the setting information is stored is correlated with the user ID and is stored in the IC card 113. The MFP 101 uses the specific information stored in the IC card 113 and acquires the setting information.

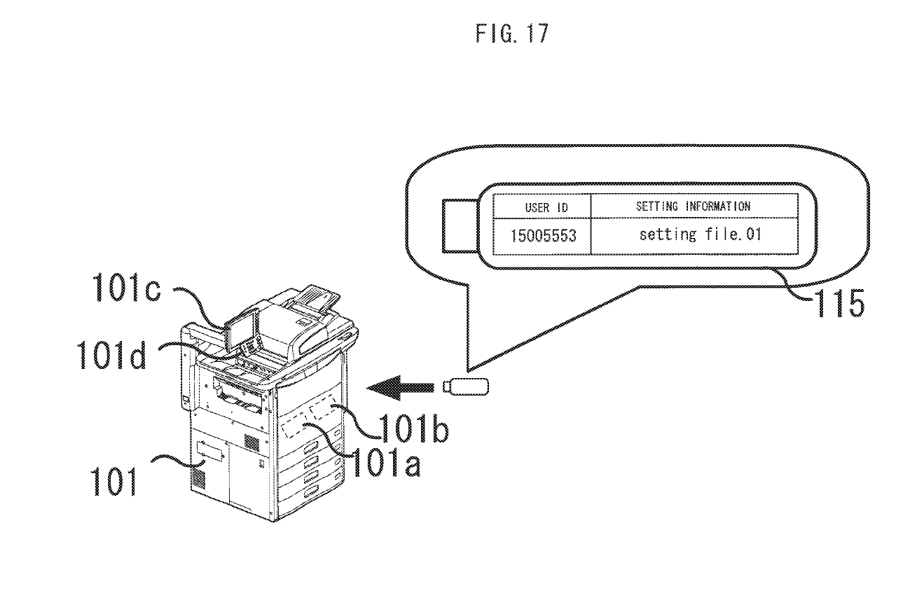

On the other hand, in a fourth embodiment, the setting information is stored in the storage area 101b or a USB memory 115 connectable to the MFP 101, and the MFP 101 uses the setting information of one of these and can cause the setting contents of the setting information to be reflected in the operation environment of the user. Besides, as shown in FIG. 17, in the USB memory 115, the setting information is correlated with the user ID and is stored, and the MFP 101 uses the user ID stored in the USB memory 115 and authenticates the user. Further, in the fourth embodiment, the setting information stored in the storage area 101b is acquired (specified) based on the user ID instead of the specific information in the first to the third embodiments.

Incidentally, in the fourth embodiment, the setting information stored in the USE memory 115 can be acquired from the MFP (for example, the MFP 102) by connecting the USB memory 115 to the MFP 102 by the operation of the user. Besides, the user ID may also be acquired by connecting the USB memory 115 to a specified apparatus.

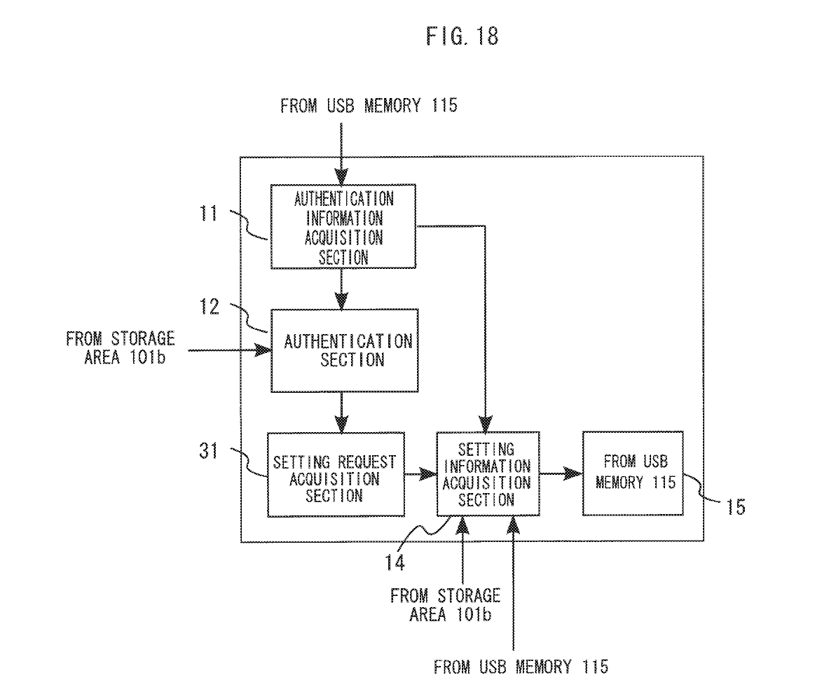

Hereinafter, a block structure of functions provided in the MFP 101 of the fourth embodiment, which relate to the acquisition of setting information and the reflection of setting contents based on the acquired setting information into the operation environment, will be described with reference to FIG. 18. A component common to the first embodiment is denoted by the same symbol and its description is omitted.

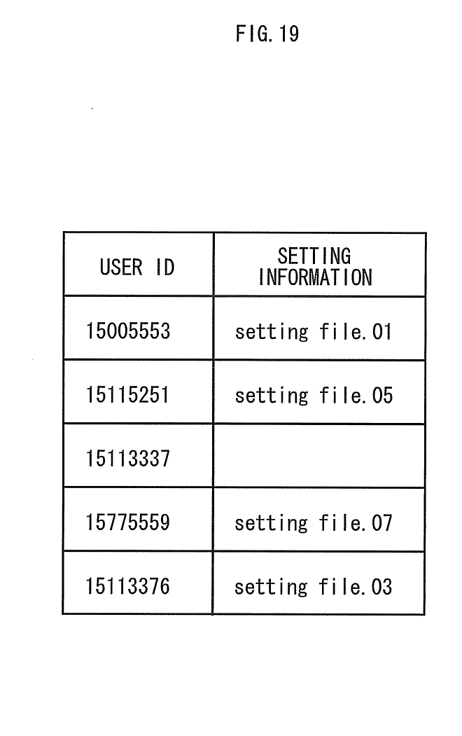

In the fourth embodiment, it is assumed that as shown in FIG. 19, in the storage area 101b of the MFP 101, the user ID of the user allowed to use the MFP 101 and the setting information stored in the storage area are correlated with each other and are stored in advance. In the data table of FIG. 19, a blank column in columns indicating setting information indicates that the setting information corresponding to the user ID is not stored in the storage area 101b.

In the fourth embodiment, an authentication information acquisition section 11 acquires the user ID from the USB memory 115 connected to the MFP 101, and sends it to an authentication section 12 and a setting information acquisition section 14.

When acquiring a notification to inform acquisition of a setting request from a setting request acquisition section 31, the setting information acquisition section 14 uses the user ID acquired from the authentication information acquisition section 11 and executes acquisition of the setting information correlated with the user ID from the storage area 101b.

Here, there is a case where the setting information can not be acquired from the storage area 101b, for example, the setting information correlated with the acquired user ID is not stored in the storage area 101b. In this case, the setting information acquisition section 14 acquires the setting information from the USB memory 115 from which the user ID was acquired.

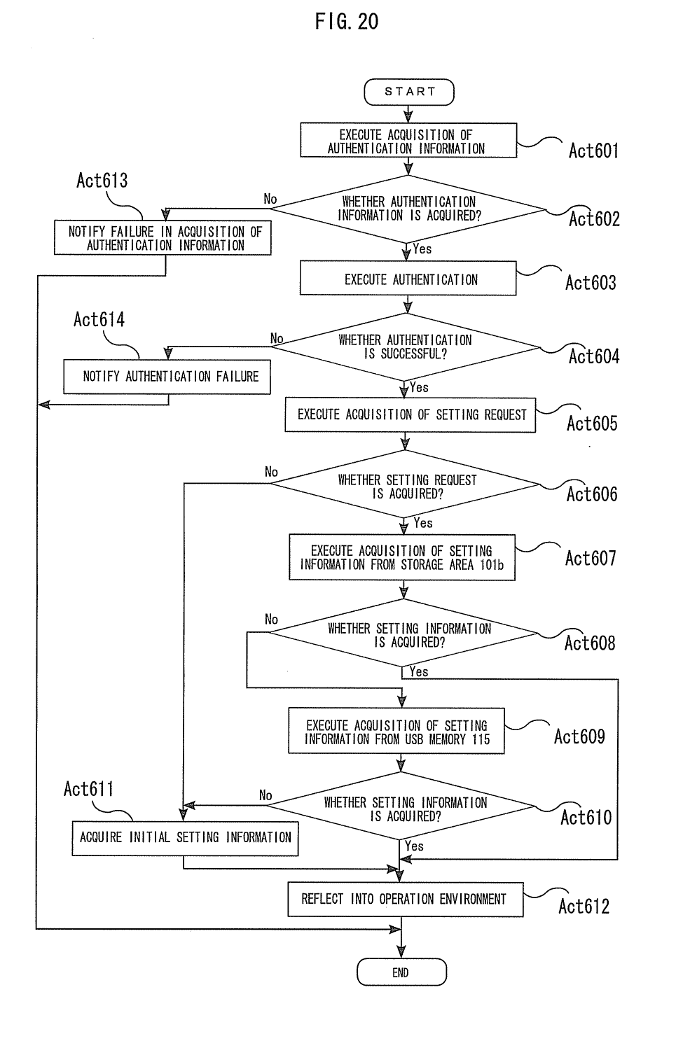

Next, in the fourth embodiment, a process flow relating to the reflection of the setting contents based on the setting information, which is stored in the storage area 101b or the USB memory 115, into the operation environment in the MFP 101 will be described with reference to FIG. 20. Incidentally, a process from the acquisition of the user ID to the determination of whether the setting request is acquired is common to the first embodiment except that the user ID is acquired from the USB memory 115, and the authentication information acquisition section 11 sends the acquired user ID to the authentication section 12 and also to the setting information acquisition section 14. Accordingly, with respect to the process from the acquisition of the authentication information to the determination of whether the setting request is acquired, its description is omitted.

First, it is assumed that the authentication using the user ID acquired from the USB memory 115 is successful at Act 604, and the setting request from the user is acquired at Act 606.

At Act 607, when acquiring a notification to inform that the setting request from the user could be acquired, the setting information acquisition section 14 uses the user ID acquired from the authentication information acquisition section 11, and executes acquisition of the setting information from the storage area 101b. Next, the setting information acquisition section 14 determines whether the setting information could be acquired from the storage area 101b (Act 608). When the setting information could be acquired, the setting information acquisition section 14 sends the setting information to the setting reflection section 15.

On the other hand, at Act 608, when it is determined that the setting information corresponding to the user ID is not stored in the storage area 101b, the setting information acquisition section 14 advances to Act 609, and executes acquisition of the setting information from the USB memory 115. Next, the setting information acquisition section 14 determines whether the setting information could be acquired from the USE memory 115 (Act 610). When the setting information could be acquired, the setting information acquisition section 14 sends the setting information to the setting reflection section 15.

On the other hand, when it is determined at Act 610 that the setting information can not be acquired, the setting information acquisition section 14 advances to Act 611, acquires the initial setting information from the storage area 101b, and sends it to the setting reflection section 15.

At Act 612, the setting reflection section 15 causes the setting contents based on the setting information acquired from the storage area 101b or the USB memory 115, or the initial setting contents based on the initial setting information to be reflected in the operation environment of the user in the MFP 101.

According to the fourth embodiment described above, also when connection to the network is not performed, the setting information is acquired and the setting contents can be reflected in the operation environment of the user.

Incidentally, as another example, similarly to the third embodiment, the acquired setting information can be stored as the setting log information in the storage area 101b. At this time, when the setting information acquisition section 14 fails in acquiring the setting information from the USB memory 115, the setting reflection section 15 (corresponding to the setting reflection section and the storage control section) can cause the setting contents based on the stored already obtained setting information to be reflected in the operation environment of the user.

### Other Embodiments

Although the description of the invention is made up to here, the invention is not limited thereto, but other embodiments can be adopted.

For example, in the third embodiment, for facilitating the understanding, the description is given to the example in which one piece of specific information is correlated with one piece of authentication information and is stored in the IC card 113. Instead of this, as in the second embodiment, an example in which plural pieces of specific information are stored can be naturally adopted. In this case, the setting information acquisition section 14 can acquire the setting information from the storage area indicated by one of the plural pieces of specific information, and the update section 43 can update the stored respective pieces of setting information into the state where the changed setting contents are reflected.

Besides, in the first to the third embodiments, although the IC card 113 is used for authentication of the user, no limitation is made thereto, and another storage medium can be used. Similarly, also in the fourth embodiment, instead of the USB memory 115, another storage medium may be used.

Further, in the first to the third embodiments, for convenience of the explanation, the MFP 101 acquires the specific information after acquiring the user ID. However, the sequence of these is not limited, and for example, the user ID and the specific information can be simultaneously acquired.

Further, in this embodiment, the setting information is acquired according to the request (setting request) of the user for the reflection of the setting contents based on the setting information. However, no limitation is made to this, and when at least one of the authentication information and the specific information is acquired, it is assumed that the request for the reflection of the setting information from the user is performed, and the process can be made to be executed.

Further, in the second embodiment, the prescription of the specific information to be used is provided by the acquisition prescription information. However, no limitation is made to this, and the setting information may be acquired by using the specific information stored in the IC card 113 at random.

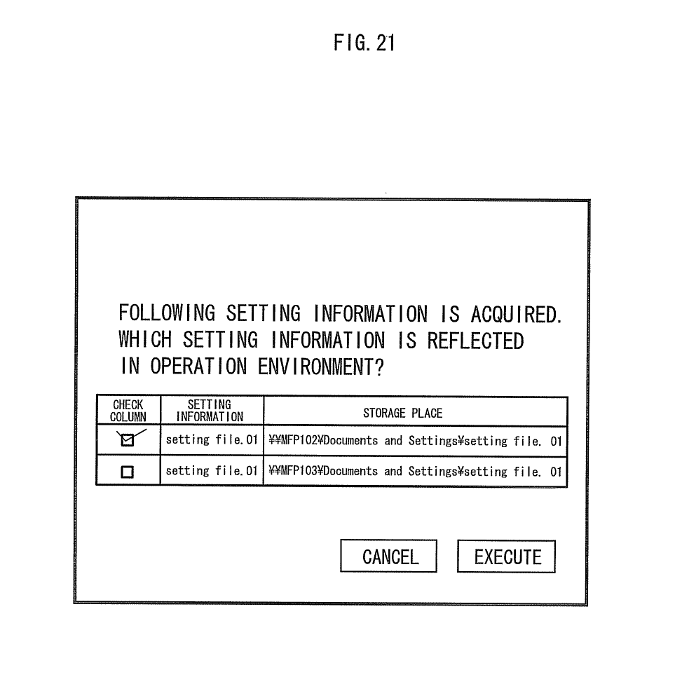

Further, as another example of the second embodiment, the setting information acquisition section 14 first acquires acquirable setting information in the setting information whose locations are indicated by plural pieces of specific information, and may present the user with information about the acquired setting information by configuring a screen as exemplified in FIG. 21. At this time, the user uses the screen, and can select the setting information used for the reflection into the operation environment. Besides, similarly, acquirable setting information in the setting information whose locations are indicated by plural pieces of specific information may be notified to the user through the display 101c or the like. At this time, the user uses the screen and can select the setting information to be acquired.

Further, in the embodiment, although the operation supporting apparatus is the MFP having the function as the image forming apparatus, no limitation is made to this, and another equipment may be naturally adopted.

Further, a program to cause a computer constituting the MFP to execute the foregoing respective operations can be provided as an object management program. In the first to the fourth embodiments, although the description is given to the example where the program for realizing the functions to carry out the invention is previously recorded in the storage area provided in the MFP apparatus, no limitation is made to this. A similar program may be downloaded to the apparatus from the network, or a similar program stored in a computer readable storage medium may be installed in the apparatus. As the recording medium, any form may be adopted as long as the program can be stored and can be read by the computer. Specifically, as the recording medium, an internal storage device, such as a ROM or RAM, installed in the computer, a portable recording medium such as a CD-ROM, a flexible disk, a DVD disk, a magneto-optical disk or an IC card, a database to hold the computer program or another computer and its database, a transmission medium on a line and the like can be enumerated. The function previously obtained by installation or download as stated above may realize the function in cooperation with the OS (Operating System) of the apparatus.

Incidentally, the program in the embodiment includes a program dynamically generated by an execution module.

Although the detailed description is given to the specific embodiments of the invention, it is apparent for one of ordinary skill in the art that various changes and modifications can be made without departing from the sprit and scope of the invention.

According to the invention, it is not necessary to provide a management apparatus to collectively store setting information, and an operation environment stored in an apparatus can be easily reflected in another apparatus.

What is claimed is:

1. An operation supporting apparatus comprising:
an authentication section to authenticate a user by acquiring authentication information from a storage medium to store the authentication information used for user authentication and specific information about a location of setting information about setting contents of an operation environment of the user;
a specific information acquisition section to acquire the specific information from the storage medium from which the authentication information is acquired;
a setting information acquisition section to acquire, when the authentication section succeeds in the authentication of the user, the setting information by using the specific information acquired by the specific information acquisition section from the storage medium from which the authentication information of the user is acquired; and
a setting reflection section to cause setting contents based on the setting information acquired by the setting information acquisition section to be reflected in the operation environment of the user.

2. The apparatus of claim 1, wherein when a request for the reflection of the setting contents based on the setting information is acquired from the user, the setting reflection section causes the setting contents based on the setting information acquired by the setting information acquisition section to be reflected.

3. The apparatus of claim 2, when a request for the reflection of the setting contents based on the setting information can not be acquired from the user, the setting reflection section causes initial setting contents of an operation environment previously set by the operation supporting apparatus to be reflected in the operation environment of the user.

4. The apparatus of claim 1, wherein when the specific information acquisition section can not acquire the specific information, or the setting information acquisition section cannot acquire the setting information, the setting reflection section causes initial setting contents of an operation environment previously set in the operation supporting apparatus to be reflected in the operation environment of the user.

5. The apparatus of claim 1, further comprising a storage control section to store the setting information acquired by the setting information acquisition section into a storage area of the operation supporting apparatus, wherein
when the specific information acquisition section can not acquire the specific information, or the setting information acquisition section can not acquire the setting information, the setting reflection section causes setting contents based on the setting information stored in the storage area of the operation supporting apparatus to be reflected.

6. The apparatus of claim 1, further comprising:
a setting change section to change a part of or all of the setting contents of the operation environment based on the setting information according to an operation input of the user; and
an update section to use, when the part of or all of the setting contents of the operation environment based on the setting information is changed by the setting change section, information about the changed setting contents and to update the setting information stored in a storage area at a location indicated by the specific information to a state where the changed setting contents are reflected.

7. The apparatus of claim 6, wherein a plurality of pieces of specific information correlated with one piece of authentication information are stored in the storage medium,
the specific information acquisition section can acquire an arbitrary number of pieces of specific information from the storage medium,
when the part of or all of the setting contents of the operation environment based on the setting information is changed by the setting change section, the update section uses information about the changed setting contents and updates the setting information stored in storage areas at locations indicated by the specific information acquired by the specific information acquisition section to a state where the changed setting contents are reflected.

8. The apparatus of claim 1, wherein one or more pieces of specific information correlated with one piece of authentication information are stored in the storage medium,
the specific information acquisition section can acquire arbitrary one or more pieces of specific information from the storage medium,
when the arbitrary number of pieces of specific information are acquired, and when the setting information acquisition section can not acquire the setting information from a storage area at a location indicated by acquired first specific information, the setting information acquisition section acquires the setting information based on second specific information indicating a location different from the first specific information.

9. An operation supporting apparatus comprising:
an authentication section to authenticate a user by acquiring authentication information from a storage medium to store the authentication information used for user authentication and setting information about setting contents of an operation environment of the user;
a setting information acquisition section to acquire, when the authentication section succeeds in the authentication of the user, the setting information from the storage medium from which the authentication information of the user is acquired; and
a setting reflection section to cause setting contents based on the setting information acquired by the setting information acquisition section to be reflected in the operation environment of the user.

10. The apparatus of claim 9, wherein when a request for the reflection of the setting contents based on the setting information is acquired from the user, the setting reflection section causes the setting contents based on the setting information acquired by the setting information acquisition section to be reflected.

11. The apparatus of claim 10, when a request for the reflection of the setting contents based on the setting information can not be acquired from the user, the setting reflection section causes initial setting contents of an operation environment previously set by the operation supporting apparatus to be reflected in the operation environment of the user.

12. The apparatus of claim 9, wherein when the setting information acquisition section can not acquire the setting information, the setting reflection section causes the initial setting contents of the operation environment previously set in the operation supporting apparatus to be reflected in the operation environment of the user.

13. An operation supporting method comprising:
authenticating a user by acquiring authentication information from a storage medium to store the authentication information used for user authentication and specific information about a location of setting information about setting contents of an operation environment of the user;
acquiring the specific information from the storage medium from which the authentication information is acquired;
acquiring, when the authentication of the user is successful, the setting information by using the specific information acquired from the storage medium from which the authentication information of the user is acquired; and
causing setting contents based on the acquired setting information to be reflected in the operation environment of the user.

14. The method of claim 13, wherein when a request for the reflection of the setting contents based on the setting information is acquired from the user, the setting contents based on the acquired setting information is reflected.

15. The method of claim 14, when a request for the reflection of the setting contents based on the setting information can not be acquired from the user, initial setting contents of an operation environment previously set by an apparatus, which is a setting object of the operation environment of the user, is reflected in the operation environment of the user.

16. The method of claim 13, wherein when the specific information can not be acquired, or the setting information can not be acquired, initial setting contents of an operation environment previously set by an apparatus, which is a setting object of the operation environment of the user, is reflected in the operation environment of the user.

17. The method of claim 13, further comprising:
storing the acquired setting information in a storage area of an apparatus which is a setting object of the operation environment of the user; and
causing, when the specific information can not be acquired, setting contents based on the setting information stored in the storage area of the apparatus to be reflected.

18. The method of claim 13, further comprising:
changing a part of or all of the setting contents of the operation environment based on the setting information according to an operation input of the user; and
using, when the part of or all of the setting contents of the operation environment based on the setting information is changed, information about the changed setting contents and updating the setting information stored in a storage area at a location indicated by the specific information to a state where the changed setting contents are reflected.

19. The method of claim 18 , wherein a plurality of pieces of specific information correlated with one piece of authentication information are stored in the storage medium,
an arbitrary number of pieces of specific information can be acquired from the storage medium,
when the part of or all of the setting contents of the operation environment based on the setting information is changed, information about the changed setting contents is used and the setting information stored in storage areas at locations indicated by the acquired specific information is updated to a state where the changed setting contents are reflected.

20. The method of claim 13, wherein one or more pieces of specific information correlated with one piece of authentication information are stored in the storage medium,
arbitrary one or more pieces of specific information can be acquired from the storage medium,
when the arbitrary number of pieces of specific information are acquired, and when the setting information can not be acquired from a storage area at a location indicated by acquired first specific information, the setting information is acquired based on second specific information indicating a location different from the first specific information.
